(19) United States
(12) Patent Application Publication
(10) Pub. No.: US 2006/0047835 A1
(43) Pub. Date: Mar. 2, 2006

(54) Method and System for LAN and WLAN access to e-commerce sites via Client Server Proxy

(76) Inventor: Jeffrey Eric Greaux, Santurce, PR (US)

Correspondence Address: JEFFREY GREAUX, 714 CERRA STREET, SANTURCE, PR, 00907, US

(21) Appl. No.: 11/160,002

(22) Filed: Jun. 4, 2005

Related U.S. Application Data
(63) Continuation of application No. 60/521,787, filed on Jul. 2, 2004.

(51) Int. Cl. G06F 15/16

(52) U.S. Cl. 709/229

(57) ABSTRACT

Outernet (definition): Electronic data LAN or WLAN (WiFi, WIMAX, Bluetooth, etc . . . ), where specific access is limited to, and e-content is specifically tailored for that particular geographical or physical location. The invention is the next evolution of Internet based e-commerce platforms. It is simply a client-server proxy that allows limited (physical and geographical) access to multiple websites, client-server software applications, or e-commerce platforms via WLAN (or LAN) communication (see Outernet definition) using the Community Domain and/or ODIPA system/protocol. That means applications, websites, and wapsites that can only be accessed through a proxy server using the Community Domain and/or ODIPA system/protocol within a definitive, limited physical and geographical area (i.e. within 300 to 2500 feet of WLAN access points, within 30 to 100 miles of WIMAX Broadcast Towers, or within the Local LAN of the Proxy Server). The e-content would ideally be tailored for that particular location. The primary devices that would utilize this access are Cell Phones, Smart Phones, PDAs, laptop computers, and non-portable desktops computers. This can provide a portable kiosk type presentation to consumers who are on the go. Some of the industries that would benefit from its use are the restaurant industry, retail outlets, shopping malls, or any industry that can use kiosks, menu driven, web, client-server, or e-commerce applications to present (any type of) electronic content to the consumer or end-user. For example, fast food restaurants could use the Invention to present their local menu via WiFi (or WIMAX) to consumers within the city or neighborhood, allowing the consumers to place on or off premise orders and purchases while making a secure credit card transactions right from their cell phone! Retail outlets could broadcast advertisements, sales and specials to local consumers who are close by the store, enticing the consumers to visit or enter. The ideal usage for the invention platform would be for shopping malls and retail outlets. A shopping mall could deploy the invention to provide on-site or Internet based electronic content to consumers tailored for that particular physical or geographical location. Consumers could then use their cell phones, PDAs, or even home PCs to access local or city-wide e-content (through the CD (Community Domain) or ODIPA (See ODIPA Defined below) based proxy server) and do things like, check inventory (to see if an item is in stock at that particular location) or make purchases. This Invention facilitates access to e-commerce sites and computer applications and making them available to portable electronic devices via wireless means (using a specialized type of DHCP called ODIPA) based on their physical location and geographical area as opposed to the availability of logical locations of the Internet. This has never been produced before because it is difficult to assign Independent DHCP Internet Protocol Addresses over wireless in a public area because one DHCP Server may assign addresses to clients that overlap another (wirelessly broadcasted) DHCP Server's address space (ranges that the other DHCP Server is using to give out IP addresses). This Invention solves that problem by using ODIPA (Outernet Dynamic IP Allocation). ODIPA allocates IP addresses in a two stage approach; where first stage uses standard DHCP to allocate a Random IP Address in a large Private Address Space for a very short period of time (after which they are released and available for use). It is in this short time period that it uses the temporarily assigned (short term) IP address to communicate with the client to establish a more long term assigned IP Address. It does this by using client and server-side databases. The database tables keep track of what IP Addresses the Client and Server are using to communicate with other Servers and Clients. After it has established which IP Addresses are in use it then assigns a long term address to the client in a second separate exchange (using a secondary private address space) and uses dynamic routing (with Virtual Network Adapters) to facilitate access from the client to subscribed e-commerce platforms. ODIPA also uses something called DHCP Scope Rotation to help avoid or minimize the chance of IP address conflicts. Scope Rotation is basically a timed and/or database initiated rotation of randomly selection subnets configured for allocating private IP address. One other reason no one has done this before is because there does not exist an established structure or network topology for the Internet and World Wide Web where access is limited to and content is specifically based on the physical or geographical location of the end-user (especially using wireless means). In most physical shopping centers and businesses you may have a landlord that owns the property and multiple businesses that are leasing out of the property. Having everyone do their own independent broadcasting would create chaos and interference within the WLAN broadcasters (Separate independent WiFi Access Points for example must be on different channels if in close proximity to one another). This Invention lays the framework for the property owner, management, or service provider to provide the means for all the tenants to independently broadcast in harmony with each other. The Invention Platform lays the foundation for a whole new type of Internet, called the Outernet. An Internet that is based on geographical and physical location. Because this invention is based on a two tier Client Server model it can facilitate access to any type of electronic content (e-content) that can be specifically tailored for that particular area or location. The e-Content can be accessed using any type of Personal or Portable Computer or hand held computer device (i.e. Palmtop, PDA, or Cell Phone).

### BACKGROUND OF INVENTION

This invention relates to the field of automated information processing, and more specifically to a computer tool for providing portable digital computer devices a method and system for accessing electronic content in specific geographical areas over a wireless distributed network.

E-commerce, or Electric Commerce, is one of the most important aspects of the internet to emerge today. It allows people to exchange goods and services easily. Any time of the day or night, you can go online and buy almost anything you want. As an instant society where convenience is a way of life, some feel one of the drawbacks of internet purchasing has been for people to have to wait for items to be delivered via postal mail. Whether it is 3-day or overnight mail, Internet purchasing does little to gratify the ‘I want it now’ generation that is used to having things when they want it (i.e. fast food). As a result, a lot of items that (potentially) could have been purchased on the Internet are bought in the retail stores and shopping outlets. So, this generation forgoes the ease of use, as well as the home privacy of the Internet, just to have to drive to a crowded shopping mall, try on several pairs of shoes only to find out the ones they want are out of stock, stand in line for long periods of time and walk great lengths because every year larger and larger malls are being built. Thus, there exists a need for the ease and privacy of the internet to be brought to the real everyday world of physical commerce.

DHCP stands for Dynamic Host Configuration Protocol, and is used to centrally allocate and manage TCP/IP configurations of client nodes. If you've got more than a handful of computers to manage, then DHCP can help to save a great deal of time and trouble in setting up and administering a TCP/IP network. DHCP offers the following features: It allows you to define “pools” of TCP/IP addresses, which are then allocated to client PCs by the server. These pools are called scopes in DHCP terminology. Not only are the TCP/IP addresses handed out, so are all the related configuration settings like the subnet mask, default router, DNS server, that are required to make TCP/IP work correctly. DHCP works across most TCP/IP routers and allocates IPs according to the subnet the request came from. This means you won't need to reconfigure a PC that is moved from one subnet to another. Addresses can be leased for periods of time—so an IP address that is not used for the duration of the lease is put back into the unallocated pool. This helps recover TCP/IP addresses that are no longer used.

This Invention has never been produced before because it is difficult to assign Independent DHCP IP addresses over wireless in a public area because one independent DHCP Server may assign addresses to clients that overlap another independent DHCP server's scope.

This Invention solves that problem by using ODIPA (Outernet Dynamic IP Allocation). ODIPA allocates IP addresses in a two stage approach; where first stage uses standard DHCP to allocate a random IP Address from a large Private Address Space for a very short period of time (after which they are released and available for use). It is in this short time period that it uses the temporarily assigned (short term) IP address to communicate with the client to establish a more long term assigned IP Address. It does this by using client and server-side databases. The database tables keep track of what IP Addresses the Client and Server are using to communicate with other Servers and Clients. After it has established which IP Addresses are in use it then assigns a long term address to the client in a second separate exchange (using a secondary private address space) and uses dynamic routing and Virtual Network Adapters to facilitate access from the client to subscribed e-commerce platforms. ODIPA also uses something called DHCP Scope Rotation to help avoid or minimize the chance of IP address conflicts. Scope Rotation is basically a timed and/or database initiated rotation of randomly selected scopes configured for allocating private IP address.

One other reason no one has done this before is because there does not exist an established structure or network topology for the Internet and World Wide Web where access is limited to and content is specifically based on the physical or geographical location of the end-user (especially using wireless means). In most physical shopping centers and businesses you may have a landlord that owns the property and multiple businesses that are leasing out of the property. Having everyone do their own independent broadcasting would create chaos and interference within the WLAN broadcasters (Separate independent WiFi Access Points for example must be on different channels if in close proximity to one another). This Invention lays the framework for the property owner, management, or service provider to provide the means for all the tenants to independently broadcast in harmony with each other.

The Invention Platform lays the foundation for a whole new type of Internet, called the Outernet. An Internet that is based on geographical and physical location. Because this invention is based on a two tier Client Server model it can facilitate access to any type of electronic content (e-content) that can be specifically tailored for that particular area or location. The e-Content can be accessed using any type of Personal or Portable Computer or hand held computer device (i.e. Palmtop, PDA, or Cell Phone).

### SUMMARY OF INVENTION

The present invention meets the above-identified needs by providing a system, method, and computer program product for providing access to e-commerce sites and computer applications and making them available to portable electronic devices via wireless means (using a specialized type of DHCP called ODIPA) based on their physical location and geographical area as opposed to the availability of logical locations of the Internet.

Accordingly, it is an object of the invention to provide a foundation, structure, and method for wireless access to e-commerce platforms that are relevant to the physical vicinity of the end user clients.

It is also an object to facilitate TCP/IP connectivity to roaming wireless client devices using temporarily allocated IP addresses without generating IP address conflicts.

A method for allocating IP addresses among end user clients on a wireless network in accordance with the invention includes providing a proxy server (Infrastructure Server) and an e-content server, with the proxy server having connectivity to both the wireless network infrastructure and one or more e-content Servers. Client requests for access to e-content are received by the Infrastructure Server and proxied to the appropriate e-content server according to the invention Community Domain hierarchy and end-user physical or geographical location.

A computer program product in accordance with the invention includes a computer usable medium residing on a computer and having control logic that permits allocation of IP addresses among end user clients on a network. The control logic includes computer readable program code for providing a proxy Server and an e-content server, with each proxy server having a plurality of ODIPA IP addresses available for allocation. Additional computer readable program code controls the proxy of client requests to e-content Servers. Other computer readable program code assigns Community Domain information to clients, with the proxy regulating network traffic distributed among the e-content servers.

A system for allocating IP addresses among clients on a network includes portable client computer devices connected to the network and one or more e-content servers. Each of the e-content servers has web, wap, or other electronic content which can be sent to the end user clients.

### DETAILED DESCRIPTION

Outernet (definition): Electronic data LAN or WLAN (WiFi, WIMAX, Bluetooth, etc . . . ), where specific access is limited to, and e-content is specifically tailored for that particular geographical or physical location.

The present invention relates to a system, method, and computer program product that provides client-server proxying to allow wireless access to multiple websites, client-server software applications, or e-commerce platforms via WLAN (or LAN) communication (see Outernet definition) using the Community Domain and/or ODIPA system/protocol. That means applications, websites, and wapsites that can only be accessed through a proxy server using the Community Domain and/or ODIPA system/protocol within a definitive, limited physical and geographical area (i.e. within 300 to 2500 feet of WLAN access points, within 30 to 100 miles of WIMAX Broadcast Towers, or within the Local LAN of the Proxy Server). The e-content would ideally be tailored for that particular location. The primary devices that would utilize this access are Cell Phones, Smart Phones, PDAs, laptop computers, and non-portable desktops computers. This can provide a portable kiosk type presentation to consumers who are on the go.

Some of the industries that would benefit from its use are the restaurant industry, retail outlets, shopping malls, or any industry that can use kiosks, menu driven, web, client-server, or e-commerce applications to present (any type of) electronic content to the consumer or end-user. For example, fast food restaurants could use the Invention to present their local menu via WiFi (or WIMAX) to consumers within the city or neighborhood, allowing the consumers to place on or off premise orders and purchases while making a secure credit card transactions right from their cell phone! Retail outlets could broadcast advertisements, sales and specials to local consumers who are close by the store, enticing the consumers to visit or enter.

The ideal usage for the invention platform would be for shopping malls and retail outlets. A shopping mall could deploy the invention to provide on-site or Internet based electronic content to consumers tailored for that particular physical or geographical location. Consumers could then use their cell phones, PDAs, or even home PCs to access local or city-wide e-content (through the CD (Community Domain) or ODIPA (See ODIPA Defined below) based proxy server) and do things like, check inventory (to see if an item is in stock at that particular location) or make purchases. For example, here is Shopping Mall Scenario 1 (offline purchase). Let's say a consumer wants to buy some clothing at the local mall. From the mall's premises (or within the city limits) the consumer would access his/her favorite store's local “Outernet” site via the Invention Client that is running on their cell phone. They would check to see if that particular store has the clothing they want in their size. They would then see whether the clothing they want is or isn't in stock and if whether or not it's available for purchase. (This could use XML technology and enable the customer to search for items based on things such as type, color, or size etc . . . ). At that point they could proceed to make a secure purchase reservation (SPR) using their encrypted e-wallet in the Invention Client and in return receive a DPR (Digital Purchase Receipt) or e-confirmation code. Next, they would drive or walk to their favorite store where they made the Outernet purchase and there they would find their clothing prepared and waiting for pickup. All they would have to do at that point is give the e-confirmation code or transfer the DPR electronically to the attendant and receives their clothing in return. Home delivery of retail products could also become a reality much like pizza delivery is today.

E-commerce Site Integration (shopping Mall Scenario 2). The Outernet Platform can also be integrated with an e-commerce site on the Internet. This would enable the final stages of a web-based transaction to be completed outside of the Internet. For example, Jane Doe decides she wants a sweater to match some new shoes she has recently purchased. So, she accesses XYZ clothing co. website on her Home PC using regular Internet access. The purchase is made on the company's e-commerce website and the “Outernet Pickup” option on the purchase screen is selected instead of mail delivery. The website then delivers an Encrypted Security Purchase Identifier (ESPI) token to her cell phone via SMS (or WiFi/WIMAX) and notifies the local Outernet site via the Invention Proxy Client-Server Platform (in the city where Jane lives). From that point Jane could then choose to drive to the local mall to pickup her purchase. Once on the mall's premises, the Outernet client on her cell phone would automatically connect with XYZ clothing store's Local Outernet site server (Invention Server) and notifies the sales clerk (through the Invention Server) that the customer has arrived. It would then upload the ESPI token to the local Invention server to complete the transaction. By the time Jane would have walked from the parking lot to the actual store in the mall, the sales clerk would have picked up the (already reserved) items and readied it for her arrival. Jane would arrive and give the sales clerk her digital purchase receipt code (based on the ESPI) and receive the purchased items in return. No long lines. Minimal waiting. An efficient sales transaction has taken place.

Fast food restaurants could especially benefit for the use of the Invention Platform. A restaurant could develop a client-server application in which the client side of the application could be downloaded to a consumer's mobile device upon first use (through the Invention Proxy). The client app could then use JAVA or some other computer language to present their restaurant menu to the consumer using rich graphics and multimedia. Thereby, enabling the restaurant to present an Interactive menu to the consumer, to which the only limit would be the application developers' imagination. The restaurant application could then access the Invention Client's information store (Invention Client's Run time environment) to obtain e-wallet information or digital receipts and certificates for payment processes. This would be a big help to small business who could broadcast their Outernet site within a whole city, enabling potential customers to view an interactive menu with pictures and sound and even read reviews of other people who have eaten at their store. They could further provide a drive through type service with Voice Over IP (VOIP) for order taking or live help.

Another beneficiary of the invention Platform could be Music Stores. A music store could develop a client-server application which the client side of the application could be downloaded (through the Invention Client) to a consumer's mobile device upon first time use. The client app could then use JAVA and XML to present the stores music selection or music MP3 list to the consumer. The application could be used further to enable the consumer to purchase and download music in MP3 or HIGHMAT format and save to flash media through the Outernet client. The Music Store application could then access the Outernet client's information store (Invention Run time environment) to obtain e-wallet information or digital receipts and certificates for payment processes. This would enable local (city wide) music stores to be virtual and operate 24/7 to local residents.

The invention platform can bring the ease, convenience and all the good things we like about the internet to the real world. It also has the capability of changing every day items like cell phone from simple communication devices to Personal Transaction and Information Mangers (PTIMs). Invention Platform system can be Potentially Larger than the Internet. It is our belief that in less than 20 years the Outernet will be larger, more widely used, and outpace the Internet in annual sales. The Outernet will be able to tap into the 98.3% of all retail sales that are transacted outside of the internet. It will be a multi-billion dollar Industry. It will dramatically change the world that we live in!

The invention is a Client—Server application that uses network protocols to provide local WLAN, Wireless WAN, or LAN users connectivity to a (local or remote) web server or an e-content server while simultaneously allowing client connectivity to other multiple web or e-content servers and sites all through the Invention Proxy Platform using the CD and/or ODIPA protocol/system.

The server—side of the application comes in two modules or modes. They are the Infrastructure Server Module (or mode) and the Content Server Module (or mode). The Infrastructure Module manages client connectivity (Using the CD system and/or ODIPA protocol) to the physical network infrastructure (WLAN, LAN, etc) and provides client connectivity to the invention Content Server Modules which house or redirect the e-content. The Content Server Modules could optionally redirect connectivity from there to a local or remote server (which may house the e-content). The Content Module can reside on the same physical server as the Infrastructure Module or be on a totally separate physical server.

The Infrastructure Server would manage client connectivity to the WLAN (or LAN) using the ODIPA Protocol and ODIPA database tables (one of which is SRD—Scope Rotation Database)) which would also run on the invention client. In essence this would allow the invention client to maintain connections to more than one Outernet Community Domain without generating IP Address conflicts. This would be ideal for a location that had multiple retailers broadcasting (via WLAN) their independent Outernet sites within a small area (such as a shopping center). This would be achieved using the OCNP protocols, (Outernet Community Negotiation Protocols) one of which is ODIPA (Outernet Dynamic Internet Protocol Allocation). This particular protocol would primarily run over TCP/IP. This also means that each Invention Client, Infrastructure Server, and Content Server would be required to have its own IP Address assignment (Static, Dynamic, Public, or Private). Note: Each Outernet Community Domain has a subset of City Domains (via WIMAX, Etc . . . ), Neighborhood Domains (via WiFi, etc), Merchant Domains and Sub-Domains (in the case of a specific vendor who was running his own invention server and wanted his domain to be listed in the merchant domain of the Mall's Neighborhood Community Domain).

The Content Server would actually house the e-content that the invention client would access. It could also optionally act as a secondary proxy server providing client connectivity to a private network or separate e-commerce infrastructure.

Bringing cyberspace to the real world (e-commerce to p-commerce (Physical Commerce).

The client-side of the application can also be referred to as a PTIM (Personal Transaction and Information Manger). The invention PTIM provides connectivity to all the community domains (and subsets like City Domains, Neighborhood Domain, and Merchant Domains) that are broadcasted, enabling the user to view and connect to every merchant in every community domain. For example, if a user were standing in the center of a large mall then he would see on his screen a stack of banners with the business logo of each merchant on every banner (see illustration) that was connected to the Invention Server. He could then select the merchant's banner he wanted to connect to. This in turn would bring up the Outernet site for that specific vendor (residing or redirected on the Invention e-Content Server). If the user happened to be in the range of more than one subset of community domains (outdoor mall or shopping plaza) then he would see on the screen a banner for each City or Neighborhood Domain with the plaza or mall logo on every banner (see illustration). If one of those banners were selected then it would put him to the merchant Domain selection screen (previously mentioned). The invention PTIM can also manage a situation where the client might be in an area where more than one community domain might be accessible, like in a mall parking lot across the street from a theater or a totally separate outdoor shopping mall. If the invention PTIM sees more than one local community domain then instead of presenting the merchant menu for a particular domain it would show all the Community Domain banners that it could detect. So, the user would see a banner for the current mall (in whose parking lot he/she were standing in), banners for the theater or separate outdoor shopping mall, and banners for any other community domains that the invention PTIM could detect. The consumer could then select the Community Domain banner that he or she wanted and bring up the Merchant Domain menu for that particular community domain.

The invention client also has additional components for keeping personal identification and merchant transaction information (in an offline store). The personal identification components would store personal information items such as e-wallets, digital tokens, digital certificates, digital signatures, cookies, etc. . . . These components could be used to securely identify and link consumers to specific Internet or Outernet based transactions. Another feature the invention client would have is LPS (Local Positioning System) capability. LPS is similar to GPS (Global Positioning System) but it works on a smaller scale. It could be used to locate a particular store in the mall relevant to the client's location or be used to locate family members or friends in your OIM (Outernet Instant Messaging) list. Note: LPS functionality would be dependant on the WLAN (or LAN, etc . . . ) network having the invention Network Client installed on the system.

Advertising: The invention platform includes advertisement display capability. Ads could be transferred to the client (PTIM) for display to the consumer based on recent purchases or browsing patterns.

CD or Community Domain System or Structure. The Invention Platform CD system allows connectivity on several separate levels. It has a high, mid and low levels of access and connectivity. The primary CDs' are: City Domains, Neighborhood Domains, Merchant Domains, and Sub-Domains.

City Domains. City Domains reside on the Invention Infrastructure Server. They can act as a proxy or pointer. They can also house listing information for the Neighborhood and Merchant Domains that are subscribed to them. This particular Infrastructure Server has Physical Connectivity to the City Wide Wireless Network Infrastructure (i.e. WIMAX Metrozones or whatever Wireless LAN or WAN infrastructure is attached to it) and may have connectivity to the Internet also. This Infrastructure Server(s) has connectivity to the subscribed Neighborhood and Merchant Domains (explained later in detail) allowing the Invention client side access to the merchants in Merchant Domains or Subscribed Neighborhood Domain Listing in the City Domain. (See Illustrations). For example Outernet Yellow Pages cuts a deal with the local WIMAX service provider for the city of New Jeffrey. They purchase several Invention Infrastructure Servers and connect them (via network) to the WIMAX Network Towers in New Jeffrey. Then they offer a subscription service to all the city businesses to broadcast their Outernet Site to the whole city instead of the just the immediate surrounding area of their Store(s). So, the businesses connect (Direct, Wireless, or through the Internet) their Invention e-Content Servers to the City Domain Infrastructure Server(s) and have their Outernet sites broadcasted throughout the city. Consumers in New Jeffrey can now use their cell phones, Laptops, or home computers to Order Chinese Food across town using menus, pictures, Video, and even V0IP for voice communication. They could see the food before ordering, read reviews of other customers that have eaten there, place specialized (dietary) cooking instructions, and even talk to the Virtual Drive Through using Voice Over IP, all via the invention client PTIM. The Chinese store that had a limited number of customers from the surrounding neighborhood area now has access to the truckers on the other side of town. Trucks that are passing through on the Interstate highway that didn't even know the store existed, are now increasing revenue and profitability for the small business. Hungry truckers on the interstate would open their cell phones or portable automobile consoles running the Invention Client PTIM. There they could look at the City Domain Directory and see banners and Logos for all the Chinese food stores in the area they were passing through. They could see pictures of the food, read reviews, make an order and even have it delivered to the Truck Stop 15 miles up the road in time for him to get there. Now the Chinese store's newest and largest customer base may be the upcoming traffic from the interstate highway.

Neighborhood Domain or ND. NDs' are a localized type of CD. They can reside on the Invention Infrastructure Server Module or e-Content Server Module. They ideally would be physically connected to a wireless broadcast network with a limited range. So, ideally they would only be of service only to PTIMS that are in close proximity to the wireless broadcast medium (i.e. 300 to 2500 feet). An example of this would be a standalone fast food restaurant with an Invention e-Content server attached to several WiFi Access Points on the Restaurant premises. The restaurant would broadcast their Outernet site (listed as a Neighborhood Domain) to the surrounding area including the restaurant, parking lot, across the street, and maybe several blocks (depending on the medium). If there are more than one Neighborhood Domains in the same area, each would be distinguished by a unique Security Identifier and Broadcast Name. PTIMS in the area would use the Invention ODIPA protocol to be able to access both NDs' simultaneously via TCP/IP using dynamically assigned IP (Internet Protocol) addresses without IP address conflicts. Neighborhood Domains can also be containers for Merchant Domains and Sub-Domains as in the case of a Mall or a large shopping center. The Mall would deploy an Invention Infrastructure Server and connect it to the Wireless Infrastructure throughout the Mall facility and Parking lots. It would also connect to all the separate e-content servers in the Mall that are owned by the separate retailers, which would each be listed as Merchant Domain Members. Neighborhood Domains can be directly connected to City Domains if wanted or they could utilize WIMAX Handoff allowing Consumers to continue interacting even if they leave the broadcast area.

Merchant Domains. A Merchant Domain is the Domain within a Neighborhood Domain. This Particular CD would be used to house a separate Community Domain under one umbrella. Ideally this would be a domain within a large shopping center such as a Mall or Plaza with more than one retailer. Merchant Domain Members would have e-content servers which are members of the same Neighborhood Domain. Merchant Domains can also be directly connected to a City Domain.

Sub-Domains. A Sub-Domain is a secondary CD for Merchant Domains. They can reside under a particular Merchant Domain member or along side a Merchant under the Neighborhood Domain. Sub-Domains can reside on an Infrastructure Server or e-Content Server. A case this would be used for is a Food Court in a Shopping Center. The PTIM Client would pull up the Neighborhood Domain (Mall or Plaza) and along with the list of all the retailers in the Merchant the Food court would be listed also a Merchant Domain Member. Upon selecting the Food Court, the PTIM would then pull up a list of all the Members of the food court Sub-Domain. Those members would be food retailers and have their own e-Content Servers. In order for an e-Content Server to have a Sub-Domain it must be a member of a Neighborhood Domain. Sub-Domains can directly connect to a City Domain if subscribed.

Community Domains follow a kind of hierarchy, with the top level being the City Domain (because it can connect to anyone with an Invention Server). All other domains follow this Hierarchy: Neighborhood Domain>Merchant Domain and Sub-Domain OR Merchant Domain>Sub-Domain.

ODIPA Protocol. ODIPA is used to avoid DHCP allocated Private IP address conflicts by other broadcasting Servers. ODIPA uses a two stage approach to establishing TCP/IP connectivity (as defined by the Internet Society Internet Architecture Board (IAB); Internet Engineering Task Force's (IETF) RFC 3700, 1700, and 1122) between the Invention Client and Server. The first stage uses DHCP to temporarily establish IP connectivity using standard private IP addressing as defined by the Internet Society Internet Architecture Board (IAB); Internet Engineering Task Force's (IETF) RFC 1918 and now obsolete (1597). The second stage uses the temporary IP connectivity that was established in the first stage to assign a more long term Private IP address to the Invention client. ODIPA Stage 2 uses client and server side databases to establish long term Private IP addressing. The Invention Client keeps a database of all the Private IP addresses assigned to it by the Invention Servers. The Invention Server in turn keeps a database of all the Invention Clients that it has assigned Private IP addresses to. ODIPA also uses something called DHCP Scope Rotation to help avoid or minimize the chance of IP address conflicts. Scope Rotation is basically a timed rotation of randomly selection Scopes configured for allocating private IP address.

ODIPA Protocol Second Stage order of operation. When an Invention Client tries to establish connectivity with a Community Domain, it uses the assigned Private IP address given to it via DHCP (RFC 1918) to talk to the server. This address is a temporarily assigned to the Invention Client until it receives a long term address from the Invention Server. Generally this address is released once a long term address has been obtained. Once the private address is obtained the Invention Client starts using the new Private IP address in place of the old one and the old one is released. The Invention Server then uses NAT (Network Address Translation) and PAT (Port Address Translation) to proxy data from the Invention Client (using the long term Private IP Address) to any Invention e-Content Servers that may be subscribed to it.

ODIPA Second Stage Private IP Address Conflicts. If the Invention Client tries to establish second stage connectivity to an Invention Server and the Server tries to assign a private IP address that the Client is already using (or has been assigned to by another separate Invention Server) then the Invention Client (after a database lookup) informs the current Invention Server that the private IP address is in use. The Invention Server then looks at its own database of assigned IP address and finds one in a different subnet (in the Private IP pool) that it has available (not in use) and offers that one to the Invention Client. If the Client is not using (or assigned by another Invention server) that Private IP Address then it will accept it from the Invention Server. If not then it will reject it and the cycle starts all over again until a Private IP is found that is not assigned by the Invention Server nor in use by the Invention Client.

ODIPA Example (First Stage): 1. Invention Client uses a standard DHCP requests to obtain a private IP address from Invention Server. 2. Invention Server uses standard DHCP replies to assign a private IP address to Invention Client from the private IP address pool of 172.16.0.0 to 172.31.255.255. 3. Invention Server assigns 172.16.1.25 Subnet mask/24 (lease time 10 minutes) to Invention Client. 4. Invention Client uses 172.16.1.25 to communicate with Invention Server and initiates Stage 2 protocols and processes.

Scope Rotation. The Invention Server keeps a minimum of three Scopes available for IP allocation at any one time (depending on the number of clients). It uses dynamic routing (with Virtual Adapters) to proxy connections to itself or e-Content Servers. If It finds (from the Scope Rotation Database) that a substantial number of clients connecting to it have assignments from another CD that is using one of the same subnets as itself then It will randomly pick another subnet for IP allocation to replace the one in conflict and all new connections will be assigned to the new subnet. The Infrastructure Server will then mark the subnet in conflict for takedown. Any users still on subnet will remain until all IP leases expire and the subnet will be taken down. This creates an equilibrium with multiple Infrastructure Servers (that may be in the same area broadcasting their own Neighborhood Domains) if they happen by chance to randomly pick one of the same subnet as each other. Please note that because each server has a minimum of three Scopes they can still operate (without rotating Scopes) if there is a subnet conflict. They do this by assigning new connections to the other subnets they both have available. It is only when there are a substantial number of new connections that are reporting a subnet in use by another Infrastructure Server that will prompt a subnet take down.

ODIPA Example (Second Stage): 1. Invention Client uses IP address obtained in first stage to make request to the Community Domain Server (Invention Server) for Outernet IP Address for Proxy Communication to available Outernet Sites. 2. CD Server (Invention Server) does an ODIPA database lookup and finds a private IP Address that is not assigned to anyone from the private IP address pool of 10.0.0.0 to 10.255.255.255. It offers 10.10.1.25 Mask/24 (lease time 3 hours) along with the gateway information to Invention Client. 3. Invention Client checks its own ODIPA database tables to see if 10.10.1.25 is in assignment (in use). 4. Invention Client finds that 10.10.1.25 is in use and sends rejection info (information about the IP in use) to the Invention Server (Infrastructure Server). 5. Invention Server logs other Community Domain (from rejection info) in the Scope Rotation Database (SRD). 6. Invention Server marks 10.10.1.0 (subnet) for take down when leases on existing clients expire and selects new random subnet for new connections. 7. Random subnet 10.55.74.0/24 is selected. 8. Infrastructure Server then offers 10.55.74.25/24 (lease time 3 hours) along with the gateway information to Invention Client PTIM. 9. Invention Client checks its own ODIPA tables to see if IP address in use. 10. Invention Client sees that 10.55.74.25/24 is not in use, update its ODIPA tables and sends acceptance data to Infrastructure Server. 11. Infrastructure Server updates its own ODIPA database with the new client information and sends CD info to Invention Client PTIM. 12. Invention Server does final configuration of proxy, Virtual Adapters, and dynamic routing for newly created subnet.

### BRIEF DESCRIPTION OF DRAWINGS

FIG. 1.1 is a public shopping area with an indoor mall in the same vicinity as an outdoor shopping center. The Mall has multiple corridors and a large parking area. Outside the mall is a shopping plaza with a restaurant and a movie theater. In FIG. 1.1 the Mall Property Management has installed WiFi Access Points (WLAN) throughout the Mall facility and Parking Lot. The WiFi Access Points are directly connected (through a Network Switch) to the Invention Infrastructure Server (which is also Mall owned and operated). The Infrastructure Server is a proxy between the network infrastructure and the invention e-Content Servers. The e-content Servers are retailer owned and are directly connected to their own respective e-commerce infrastructures. The same applies to the Outdoor Plaza with the restaurant and movie theater.

FIG. 1.1 also shows four consumers with Portable Computer Digital Devices. Two of those devices are Cell Phones (Smartphones) and two are Personal Digital Assistants (PDAs), all with WiFi capability. The Smartphones and PDAs are running the Invention Client PTIM on them. FIG. 1.1 shows the ODIPA IP addresses that the cell phones and PDAs have received from both CD Neighborhood Domains (Mall CD and Outdoor Plaza CD). The Cell phones and PDAs will use each IP address to communicate with their respectively assigned CD Infrastructure Server which will forward and proxy network connectivity to the e-Content Servers via TCP/IP.

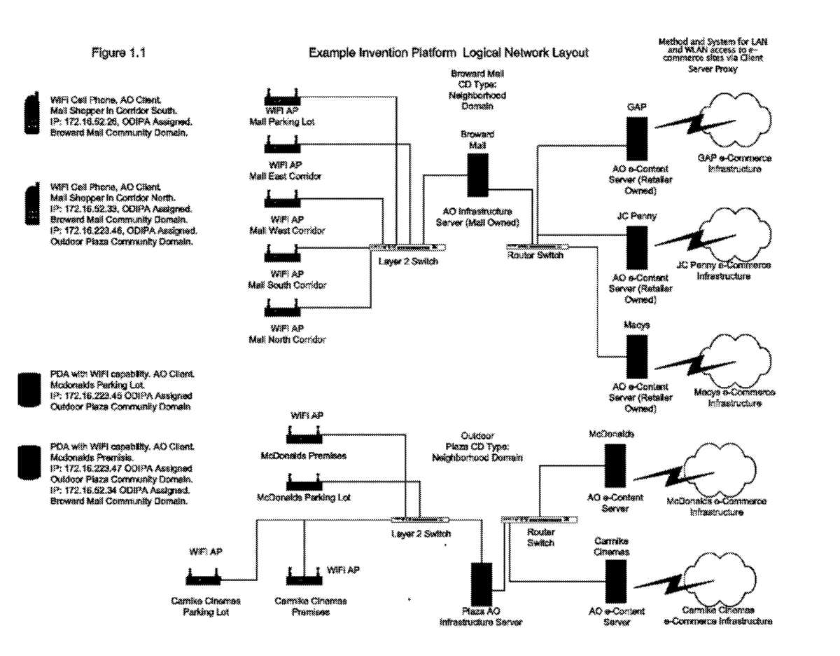

What is claimed is:

1. A method for facilitating access to electronic computer programs or electronic content among multiple portable digital device clients on a network or wireless network, comprising the steps of: (a) providing one or more infrastructure Servers, each Infrastructure Server providing network connectivity to the network infrastructure and e-Content Servers, (b) providing one or more e-Content servers, each e-Content server housing the electronic content or access to the electronic content to be sent to the end-user digital client devices through the Infrastructure Server; (c) receiving client requests for allocation of IP addresses; and (d) assigning IP addresses to clients using client and server side databases, the client and server side databases utilizing the ODIPA method or protocol.

2. The method of claim 1 wherein the step of receiving client requests for allocation of IP addresses further includes using ODIPA, which first uses standard DHCP to temporarily assign random, short term private IP addresses to end-user clients.

3. The method of claim 2 wherein the step of assigning IP addresses further includes end-user client using first obtained short term IP address to communicate with infrastructure server to assign long term private IP address.

4. The method of claim 3, and further comprising the step of Infrastructure Server allocating three or four different ODIPA (DHCP type) scopes with randomly selected subnets and inputting information into server-side ODIPA IP database (IPD) and ODIPA Subnet Rotation Database (SRD).

5. The method of claim 4, and further comprising the step of Infrastructure Server offering a randomly selected IP address from one of the scopes and other DHCP info to end-user client device.

6. The method of claim 5, and further comprising the step of end-user client device checking its ODIPA Client Database (OCD) to see if IP address offered is in use or has been assigned to it by another Infrastructure Server.

7. The method of claim 6, and further comprising the step of either accepting IP address offered (if not in use) or rejecting IP address offered because it is in use or assigned by another separate Infrastructure Server.

8. The method of claim 7, wherein the step of end-user client rejecting IP address further includes Infrastructure server updating the Scope Rotation Database (SRD) with rejection info which also includes the information about the other infrastructure Server and offers another randomly selected IP address from secondary or tertiary scopes to end-user client device.

9. The method of claim 8, and further comprising the step of Infrastructure Server counting the number of end-user clients that are rejecting IP addresses offered from any one of the scopes and if substantial then allocating additional scope with randomly selected subnet and assigning newly connected clients IP addresses from the new scope.

10. The method of claim 9, and further comprising the step of deactivating scope with substantial number of client IP rejections when all IP leases are expired.

11. The method of claim 7, wherein the step of accepting IP address offered further includes updating ODIPA Client Database with Infrastructure Server Information.

12. The method of claim 11, further comprising the step of releasing short term IP address offered and switching to long term IP address to communicate with Infrastructure Server and access e-Content Servers available.

13. A computer program product comprising a computer usable medium having control logic stored therein and residing on a server to permit allocation of IP addresses and access to e-Content Servers among end-user clients on a network or wireless network, said control logic comprising: (a) computer readable program code means for providing one or more infrastructure Servers, each Infrastructure Server providing network connectivity to the network infrastructure and e-Content Servers; (b) computer readable program code means for providing one or more e-Content servers, each e-Content server housing the electronic content or access to the electronic content to be sent to the end-user digital client devices through the Infrastructure Server; (c) computer readable program code means for receiving client requests for allocation of IP addresses; and (d) computer readable program code means for assigning IP addresses to clients using client and server side databases, the client and server side databases utilizing the ODIPA method or protocol.

14. The computer program product of claim 13, wherein the means for assigning IP addresses further includes utilizing the ODIPA SRD, IPD, and OCD databases.

15. The computer program product of claim 14, and further comprising means for associating each client with a unique session identifier.

16. The computer program product of claim 15, and further comprising means for maintaining client access to its assigned Infrastructure Server and e-Content Servers for the duration of the session.

17. The computer program product of claim 16, and further comprising means for monitoring the network for receipt of data from additional clients.

18. A system for allocating IP addresses and access to e-Content Servers among end-user clients on a network or wireless network, comprising: (a) a plurality of client computers connected to the network or wireless network; (b) one or more infrastructure Servers, each Infrastructure Server providing network connectivity to the network infrastructure and e-Content Servers; and (c) a processor connecting the network and the Infrastructure Servers, said processor including (i) ports for receiving client requests for allocation of IP addresses and for providing connectivity between end-user clients, Infrastructure Server and allocated e-Content Servers, and (ii) an output connected to the Infrastructure Server.

19. The system of claim 18, wherein the Infrastructure Server computer includes a directory containing a copy of the e-Content Servers that have been assigned to the Infrastructure Server and end-user clients.

20. The system of claim 19, wherein the server computer includes a plurality of directories, each directory containing a copy of the e-Content Servers that have been assigned to the Infrastructure Server and end-user clients and each end user client computer having access only to that directory.
